(19) United States
(12) Patent Application Publication
(10) Pub. No.: US 2020/0011972 A1
(43) Pub. Date: Jan. 9, 2020

(54) DISTANCE MEASUREMENT DEVICE

(71) Applicant: Hitachi-LG Data Storage, Inc., Tokyo (JP)

(72) Inventor: Kozo Masuda, Tokyo (JP)

(21) Appl. No.: 16/421,512

(22) Filed: May 24, 2019

(30) Foreign Application Priority Data
Jul. 4, 2018 (JP) 2018-127589

(51) Int. Cl. G01S 7/48; G06T 7/521; H04N 5/235; G01S 17/89

(52) U.S. Cl. CPC G01S 7/4808; G06T 7/521; G06T 2207/10028; G01S 17/89; H04N 5/2351

(57) ABSTRACT

A distance measurement device 1 has a light emitting unit 11, a light receiving unit 12, and a distance calculation unit 13, and outputs distance data for each pixel position to the subject. A saturation detection unit 14 detects that the light reception level in the light receiving unit 12 is saturated. In a case in which the saturation is detected, an interpolation processing unit 15 performs an interpolation process using the distance data of a non-saturation region close to a saturation region on the distance data of the saturation region among the distance data output from the distance calculation unit 13. In the interpolation process, the distance data is replaced with the distance data of one pixel of the non-saturation region, or linear interpolation or curve interpolation is performed using the distance data of a plurality of pixels.

### CLAIM OF PRIORITY

The present application claims priority from Japanese patent application serial No. JP 2018-127589, filed on Jul. 4, 2018, the content of which is hereby incorporated by reference into this application.

### BACKGROUND OF THE INVENTION

### (1) Field of the Invention

The present invention relates to a distance measurement device that measures a distance to a subject on the basis of a flight time of light.

### (2) Description of the Related Art

There is known a technology of measuring a distance to a subject on the basis of a flight time of light and outputting the distance as an image (distance image) displaying the distance. This method is referred to as a time-of-flight (TOF) method, in which irradiation light is emitted from a distance measurement camera (hereinafter referred to as a TOF camera or simply a camera), light reflected from a subject is detected by a sensor, and a distance is calculated from a time difference between the irradiation light and the reflected light. At this time, in a case in which the distance to the subject is too close or a reflectance of the subject is large, intensity of the reflected light is too strong, a detection level (charge amount) of the sensor is saturated, and the distance cannot be measured correctly. As a countermeasure to avoid such saturation, JP 2011-064498 A discloses that an imaging condition is set on the basis of information on a distance to a subject, and in the case of the subject to which the distance is close, amount of emitting light is reduced. In addition, JP 2017-133853 A discloses setting light reception timings so as to receive reflected light from a close distance side by dividing a light reception period to a plurality of light reception periods.

### SUMMARY OF THE INVENTION

Although the technologies described in the patent documents are effective for the countermeasure against saturation in the case of a subject close to a camera, a partial region may be saturated in the same subject in some cases. For example, in a case in which a distance to a person standing toward a camera is measured, although an outline portion of the person may be correctly measured, a central portion may be saturated and a part of a distance image may be omitted in some cases. Although the reason will be described later, since a reflection surface is almost orthogonal to irradiation light in the saturation region, it is considered that an intensity of reflected light is larger than that of a peripheral region and a light reception level is saturated. As a result, since a region is in subjects that are present at substantially the same distance from the camera and inclination angles of a reflection surface are not uniform, a region where it is impossible to measure the distance partially occurs. This phenomenon is similar to a case in which a reflectance of a surface material of the subject is not uniform, and a region where it is impossible to measure the distance partially occurs in a region of a high reflectance.

In the patent documents, although the influence of the distance and the reflectance of the entire subject are taken up, problems of partial saturation due to a surface state (an inclination angle and a reflectance) in the same subject are not taken into consideration.

An object of the present invention is to provide a distance measurement device capable of supplementing distance data of a region in a case in which a light reception level of a partial region of a subject is saturated and it is impossible to perform measurement.

A distance measurement device according to the present invention measures a distance to a subject by a flight time of light. The distance measurement device includes a light emitting unit that irradiates the subject with light generated from a light source, a light receiving unit that detects light reflected from the subject by an image sensor in which pixels are arranged in a two-dimensional shape, a distance calculation unit that calculates the distance to the subject for each pixel position from a detection signal of the light receiving unit and outputs distance data, a saturation detection unit that detects that a light reception level of the image sensor in the light receiving unit is saturated, an interpolation processing unit that performs an interpolation process using the distance data of a non-saturation region close to a saturation region on the distance data of the saturation region among the distance data output from the distance calculation unit when the saturation detection unit detects the saturation, and an image processing unit that generates a distance image of the subject on the basis of the distance data output from the interpolation processing unit.

According to the present invention, even in a case in which a partial region of the subject cannot be measured due to the saturation, it is possible to supplement the distance data by the interpolation process and provide a distance image without omission.

### BRIEF DESCRIPTION OF THE DRAWINGS

These and other features, objects and advantages of the present invention will become more apparent from the following description when taken in conjunction with the accompanying drawings wherein:

FIG. 1 is a configuration diagram showing a distance measurement device according to Example 1;

FIG. 2 is a diagram showing a relationship between a TOF camera and a subject (a person);

FIG. 3 is a diagram for describing signal waveforms of irradiation light and reflected light and a method of calculating a distance;

FIG. 4 is a diagram showing an example of a measurement state of a subject and saturation occurrence;

FIG. 5 is a diagram schematically showing a result of distance measurement for the subject of FIG. 4;

FIG. 6 is a diagram showing a direction of reflected light on a surface of the subject; FIG. 7 is a diagram for describing an interpolation process at the time of the saturation occurrence;

FIG. 8 is a flowchart showing a procedure of the interpolation process;

FIG. 9 is a diagram for describing an effect of the interpolation process;

FIG. 10 is a diagram for describing the interpolation process in Example 2;

FIG. 11A is a flowchart showing the procedure of the interpolation process;

FIG. 11B is a flowchart showing the procedure of the interpolation process;

FIG. 12A is a diagram for describing an interpolation method between two points; and

FIG. 12B is a diagram for describing the interpolation method between the two points.

### DETAILED DESCRIPTION OF THE EMBODIMENT

Hereinafter, embodiments of the present invention will be described using the drawings.

### EXAMPLE 1

FIG. 1 is a configuration diagram showing a distance measurement device according to Example 1. A distance measurement device 1 measures a distance to a subject such as a person by a time-of-flight (TOF) method, displays the measured distance to each portion of the subject, for example, in color, and outputs the distance as a two-dimensional distance image.

The distance measurement device 1 includes a TOF camera 10 that measures the distance to the subject by the TOF method and outputs distance data, a saturation detection unit 14 that detects that a light reception level (accumulated charge) of an image sensor in a light receiving unit 12 in the TOF camera 10 is saturated, an interpolation processing unit 15 that stores distance data in a non-saturation region in a memory, reads the distance data in the non-saturation region, and performs an interpolation process of distance data of a saturation region, and an image processing unit 16 that performs a colorization process of changing a color of a subject position on the basis of the distance data after the interpolation process and outputs a distance image.

The TOF camera 10 includes a light emitting unit 11 that generates pulse light from a light source such as a laser diode (LD) or a light emitting diode (LED) and irradiates the subject with the light, the light receiving unit 12 that detects the pulse light reflected from the subject by an image sensor such as a CCD or a CMOS, and a distance calculation unit 13 that drives the light emitting unit 11 and calculates the distance to the subject from a detection signal of the light receiving unit 12. Note that, operations of each of units are controlled by a CPU (not shown).

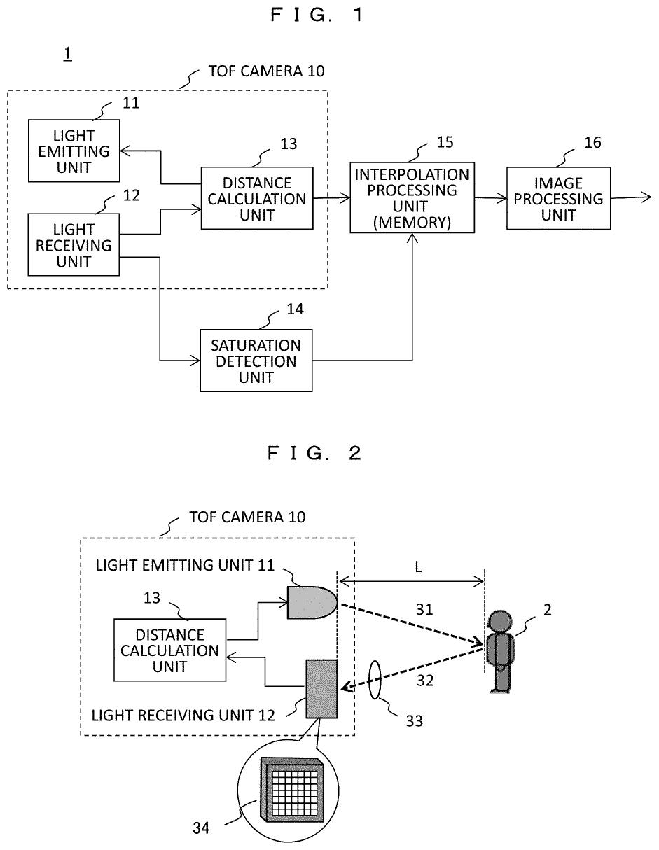

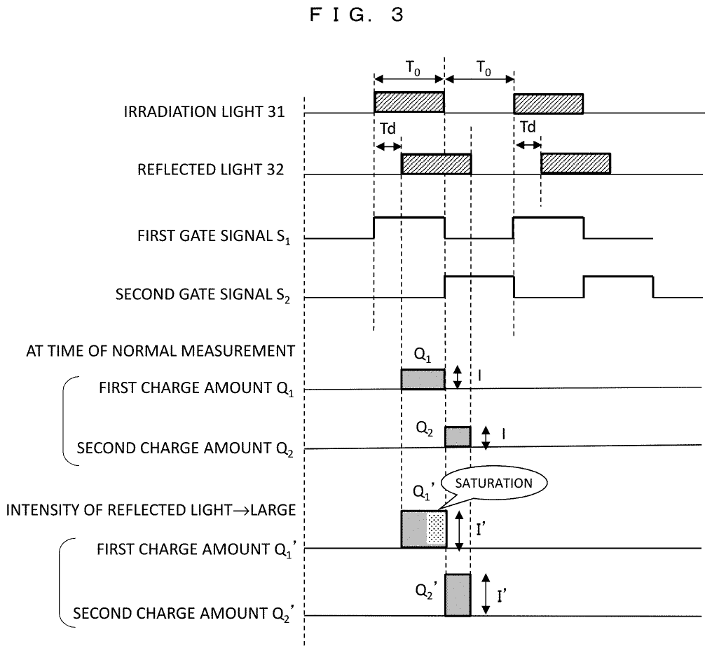

FIGS. 2 and 3 are diagrams for describing a principle of the distance measurement by the TOF method. In the TOF method, the distance is calculated on the basis of a time difference between an irradiation light signal and a reflected light signal, that is, a flight time of light.

FIG. 2 is a diagram showing a relationship between the TOF camera 10 and a subject 2 (for example, a person). The TOF camera 10 includes the light emitting unit 11 and the light receiving unit 12, and emits irradiation light 31 for distance measurement from the light emitting unit 11 to the subject 2. Infrared light or the like is used as the irradiation light. The light receiving unit 12 receives reflected light 32 reflected by the subject 2 through an objective lens 33, and outputs a charge amount accumulated in each pixel position as a signal by an image sensor 34 in which pixels are arranged in a two-dimensional shape, such as a CCD. Here, it is assumed that the subject 2 is present at a position separated from the TOF camera 10 (the light emitting unit 11 and the light receiving unit 12) by a distance L.

FIG. 3 is a diagram for describing signal waveforms of the irradiation light and the reflected light and the method of calculating the distance. Until the irradiation light 31 of the pulse width To is emitted and the reflected light 32 is received, a delay time Td is generated by a flight time to the subject 2. A relationship between the distance L to the subject 2 and the delay time Td is represented as Formula (1) in a case in which a speed of light is c.

L=Td×c/2 (1)

That is, the distance L can be calculated by measuring the delay time Td. However, in this measurement method, since it is required to measure the delay time Td with high accuracy, it is necessary to count the delay time by driving a clock of a high speed.

On the other hand, there is a method in which a light reception period is divided into a plurality light reception periods, the delay time Td is indirectly obtained from a light reception amount (accumulated charge amount) of each period, and the distance L is measured, without directly measuring the delay time Td. In the present example, this indirect measurement method is adopted.

In the indirect measurement method, with respect to an irradiation pulse To of one time, a period is divided into, for example, two periods, and a light reception operation is performed. That is, the light reception period of the reflected light 32 is a period of a first gate signal S₁ and a second gate signal S₂, and each equals to a length of the irradiation pulse T₀. In this method, a first charge amount Q₁ accumulated in the period of the first gate signal S₁ and a second charge amount Q₂ accumulated in the period of the second gate signal S₂ are measured.

The first and second charge amounts Q₁ and Q₂, the delay time Td, and the distance L to the subject at this time can be calculated by Formulas (2) to (4). Here, it is assumed that a charge amount per unit time generated by photoelectric conversion of a sensor is I.

Q₁=I×(T₀−Td), Q₂=I×Td (2)

Td=T₀×Q₂/(Q₁+Q₂) (3)

L==T₀×Q₂/(Q₁+Q₂)×c/2 (4)

That is, it is possible to calculate the distance L by measuring the first charge amount Q₁ and the second charge amount Q₂. According to the indirect measurement method, since it is not necessary to measure the delay time Td with high accuracy, it is practical.

However, the generated charge amount I per unit time depends on the intensity of the reflected light. Therefore, in a case in which the distance to the subject is close or the reflectance is large, the intensity of the reflected light may become excessive (the generated charge amount is indicated by I′), and the accumulated charge amount in the light reception period may exceed an allowable value of the sensor. As a result, for example, a saturation phenomenon occurs in a measurement value of the first charge amount Q₁′, and it is impossible to correctly measure the distance.

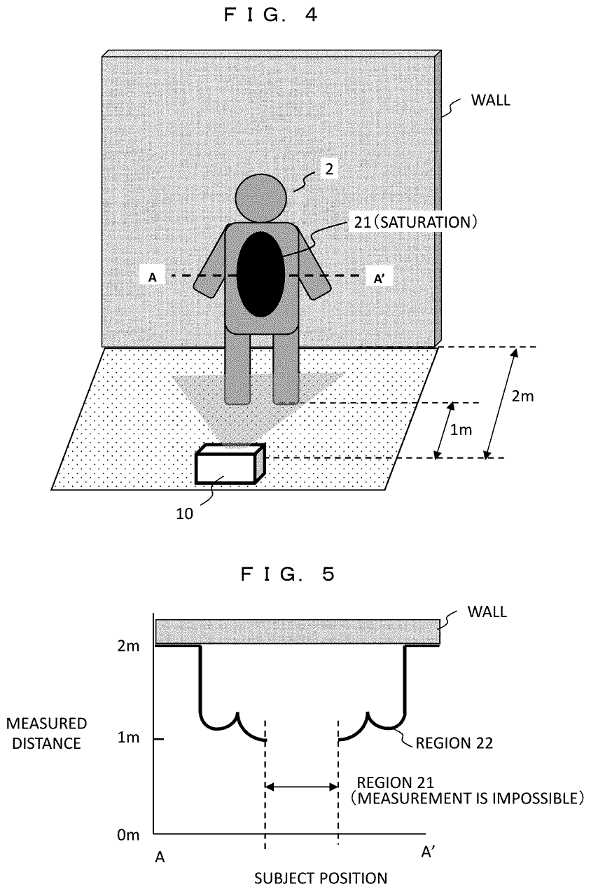

FIG. 4 is a diagram showing an example of a measurement state of the subject and saturation occurrence. In a state in which the distance to the subject (person) 2 standing in front of a wall is measured by the TOF camera 10, the distance to the person 2 is a short distance of about 1 m. At this time, a region 21 of a front center portion of the person facing the camera 10 is likely to be saturated. The reason is considered to be that the intensity of the reflected light returning to the camera 10 is increased since a reflection surface is substantially orthogonal to the irradiation light in the region of the central portion 21.

FIG. 5 is a diagram schematically showing a result of the distance measurement for the subject of FIG. 4. The measured distance between A-A′ of the subject (person) 2 is shown, but in the region 21 of the central portion, the measurement is impossible because of the saturation occurrence. On the other hand, in a region 22 around the central portion 21, which is other than the central portion 21, the measurement is normally performed.

In the present example, in a case in which a measurement impossible region due to the saturation occurs, data is interpolated using measurement data of a non-saturation region close to the measurement impossible region.

Here, a factor of the saturation occurrence shown in FIGS. 4 and 5 is considered.

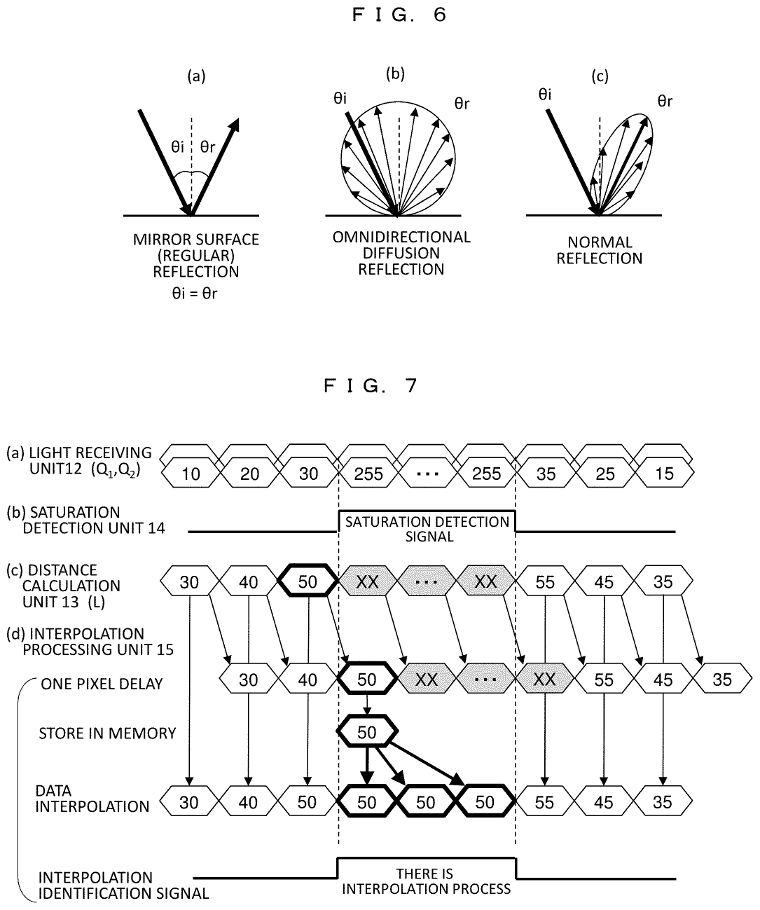

FIG. 6 is a diagram showing a direction of the reflected light on a surface of the subject. (a) shows a reflection direction on a mirror surface of metal or the like, and an incident angle θi and a reflection angle θr become equal (regular reflection). That is, since the reflected light is only in one direction, in a case in which the incident angle θi is small (vertical incidence), strong reflected light is returned to the camera and the saturation is likely to occur. On the other hand, in a case in which the incident angle θi is large (oblique incidence), the reflected light does not return to the camera, and the distance cannot be measured.

(b) shows the reflection direction on a surface of a diffusion material such as resin, and the reflected light is reflected in all directions (referred to as omnidirectional diffusion reflection) regardless of the incident angle θi. In this case, the reflected light returns to the camera regardless of the inclination angle of the subject surface, but the intensity of the reflected light received by the camera is reduced since the light is diffused light.

(c) shows the reflection direction of a general material, and states of both of the regular reflection of (a) and the omnidirectional diffusion reflection of (b) are mixed. That is, the reflection direction is dispersed with a certain width using the direction θr determined by the regular reflection as a peak. As a result, in a case in which the incident angle θi is small (vertical incidence), the strong reflected light close to the peak in the dispersion returns to the camera and the saturation is likely to occur. On the other hand, in a case in which the incident angle θi is large (oblique incidence), weak reflected light deviated from the peak in the dispersion returns to the camera, but the intensity is sufficient for the distance measurement.

In the subject of the person shown in FIG. 4, a surface state (clothing) of the subject of the person corresponds to (c). Therefore, it is considered that, as shown in FIG. 5, the strong reflected light close to the peak is returned from a flat portion (the region 21) of the person facing the camera and the saturation occurs, and since the reflected light is the weak reflected light in an inclination portion (the region 22) in the vicinity thereof, the saturation does not occur. In other words, even though the distance is substantially the same within the same subject, likelihood of the saturation changes in the inclination state of the reflection surface, and the distance data can be acquired in the inclination region. In the present example based on this, the distance data of the saturation region is interpolated by the distance data of the non-saturation region close to the saturation region.

FIG. 7 is a diagram for describing the interpolation process at the time of the saturation occurrence. Here, output data at each pixel position by the light receiving unit 12, the saturation detection unit 14, the distance calculation unit 13, and the interpolation processing unit 15 are shown. A horizontal axis indicates an order of a data process, and a scanning is performed in a horizontal direction (or a vertical direction) in an order sequence in which each of pixels of the image sensor in the light receiving unit is arranged.

(a) is the output data of the light receiving unit 12 and shows an accumulated charge amount detected at each pixel position. As described with reference to FIG. 3, two channels of signals of the charge amount Q₁ in the first gate and the charge amount Q₂ in the second gate are output, however, here only data of one channel is shown. The charge amount is normalized by 8 bits, and a data value “255” means the maximum value, that is, the saturation state. Note that, a value other than the maximum value may be determined in advance as the saturation state, and determination may be performed based on the value.

(b) is an output of the saturation detection unit 14. In a case in which the output data of the light receiving unit of (a) reaches the saturation level “255”, a detection signal (here, a high level) indicating a saturation state is output.

(c) is output data of the distance calculation unit 13. The distance (L) is calculated and output by Formula (4) based on output data (Q₁, Q₂) from the light receiving unit 12 of (a). At this time, “XX” indicating that calculation is impossible is output without calculation in the saturation region.

(d) shows a process in the interpolation processing unit 15. First, the output data of the distance calculation unit 13 of (c) is delayed by one pixel. In a case in which the saturation detection unit 14 of (b) detects the saturation, the distance data of the pixel of the non-saturation region close in the scan direction is stored in the memory. In addition, the pixels in the saturation region are replaced with the data stored in the memory and are output. In this example, distance data “XX” of the saturation region is replaced with data “50” of the non-saturation region close to one pixel before. For the pixels in the non-saturation region, the output data of the distance calculation unit 13 is output as it is.

In addition, during a period in which the interpolation processing is performed, an interpolation identification signal is given to the distance data and is output. It is assumed that the interpolation identification signal is a digital signal of a high level. Alternatively, the interpolation identification signal may be a signal of a low level or a signal of a specific code pattern. However, these signals are configured with values (a maximum output value or a minimum output value) different from a possible value of the distance data. The distance data after the interpolation process and the interpolation identification signal are transmitted to the image processing unit 16.

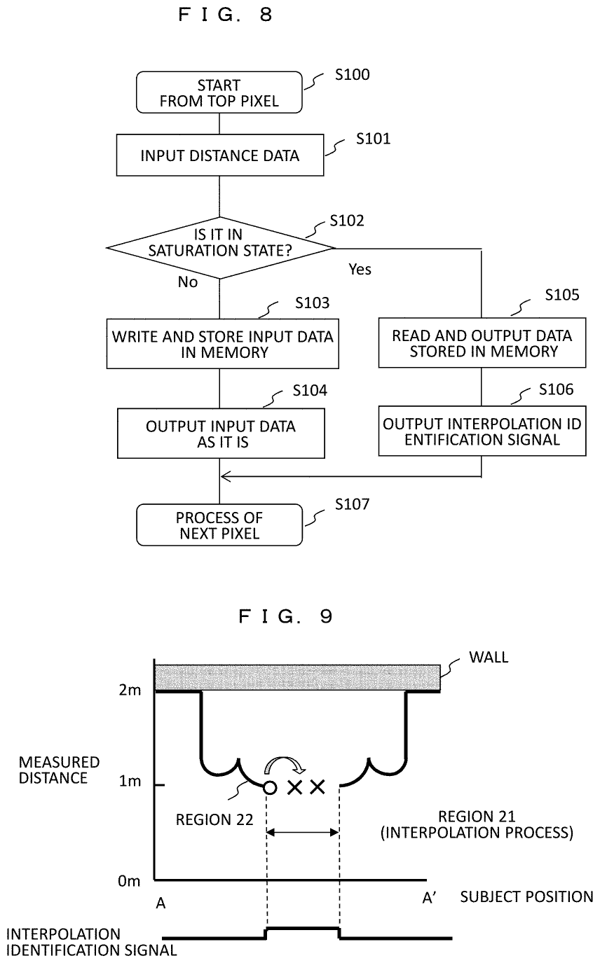

FIG. 8 is a flowchart showing a procedure of a data interpolation process by the interpolation processing unit 15. The following flow is executed in order of arrangement for each pixel.

In S100, the process is started from a top pixel of a line. In S101, distance data of the corresponding pixel is input from the distance calculation unit 13. In S102, it is determined whether or not the light reception level of the corresponding pixel is saturated. Therefore, the saturation detection unit 14 determines whether or not at least one of the charge amounts Q₁ and Q₂ of the pixel has reached the saturation level. In a case in which the both are not saturated, the process proceeds to S103, and in a case in which at least one is saturated, the process proceeds to S105.

In S103, the input distance data is stored in the memory. When other data is already stored in the memory, the data is rewritten. In S104, the input data is output as it is.

In S105, the distance data stored in the memory is read and is output as the distance data of the corresponding pixel. Here, as a result of rewriting of the memory in S103, the data read from the memory in S105 is the data in the non-saturation region of one pixel before the saturation region. In the example of FIG. 7, data “50” is replaced and output. In S106, the interpolation identification signal indicating that the data is interpolated is output.

Upon the above process is completed, the process proceeds to the process of the next pixel in S107. After an end pixel of the line is ended, the process is performed on the next line.

FIG. 9 is a diagram for describing the effect of the interpolation process. FIG. 9 shows the effect of the interpolation process superimposed on FIG. 5. The region 21 in which it is determined that it is impossible to perform the measurement due to the saturation occurrence is interpolated (replaced) to be output as indicated by × mark by using the data (◯ mark) of the non-saturation region 22 adjacent to the region 21. At this time, since the data used for the interpolation (replacement) is data of a pixel closest to the saturation region, data close to an actual distance of the subject can be output. In addition, since the interpolation identification signal is output for the interpolated region, it is possible to perform a process distinguished from other regions in image analysis using the distance image.

In the above description, in order to make explanation of the operation of the example easy to understand, it is assumed that it changes stepwise from the non-saturation state to the saturation state in a boundary portion between the non-saturation region and the saturation region, and the interpolation is performed using the data of the one pixel before the non-saturation region adjacent to the saturation region. However, the intensity of the reflected light from the actual subject often changes continuously with a certain width (transition region) from the non-saturation state to the saturation state. Therefore, interpolating the data of one pixel before the saturation region as described above uses the data in the transition region in which a partial saturation state is mixed, and the effect of the interpolation process cannot be sufficiently obtained. Therefore, when the number of pixels included in the width direction of the transition region is N, it is preferable to use pixel data of the non-saturation region separated from the saturation region by N pixels as the pixel data used for the interpolation. However, since this pixel number N depends on a pixel configuration of the light receiving unit of the camera and a type of the subject, it is assumed that the pixel number N is obtained in advance. In addition, it is assumed that a pixel adjacent to the saturation region across the transition region together with a pixel adjacent to the saturation region is referred to as a pixel “close to” the saturation region. Furthermore, although the interpolation is performed using one piece of pixel data in the non-saturation region in the above example, as a modified example thereof, the interpolation may be performed using an average value of a plurality of pieces of the pixel data in the non-saturation region close to the saturation region.

According to Example 1, there are the effects that even in a case in which it is impossible to perform the measurement due to the saturation in the partial region of the subject, it is possible to supplement the distance data by the interpolation process by the pixel data close to the saturation region, and it is possible to provide the distance image without omission.

### EXAMPLE 2

Example 2 is different from Example 1 in a method of the interpolation process performed by the interpolation processing unit 15. That is, in Example 2, the distance data of the saturation region is interpolated using a plurality of pieces of distance data of the non-saturation region close to the saturation region before and after. Therefore, it is possible to preferably interpolate the distance data in a case in which the distance data changes significantly in the saturation region.

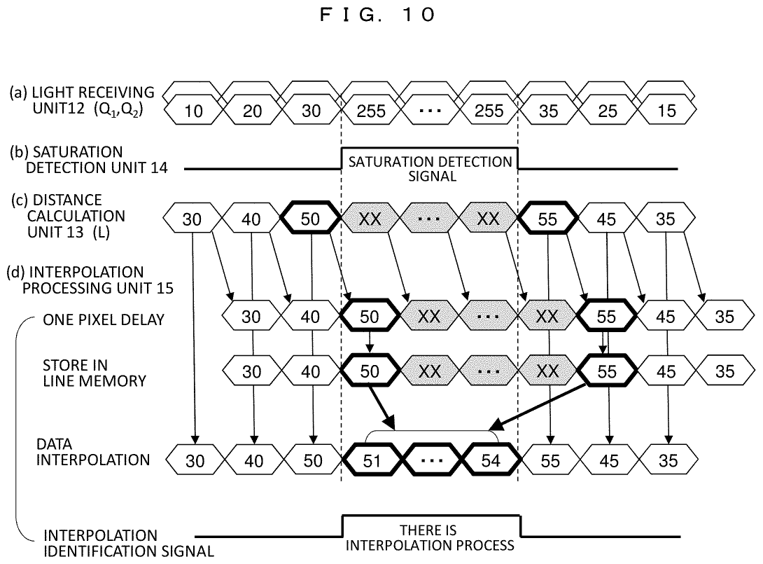

FIG. 10 is a diagram for describing the interpolation process in Example 2. Similarly to FIG. 7, output data at each pixel position in the light receiving unit 12, the saturation detection unit 14, the distance calculation unit 13, and the interpolation processing unit 15 is shown. (a) to (c) are the same as in FIG. 7, and different parts will be described here.

The interpolation processing unit 15 of (d) includes a line memory, and stores data of one line (horizontal direction or vertical direction) of a pixel column. In a case in which the saturation detection unit 14 of (b) detects the saturation, two adjacent non-saturation distance data immediately before and after the scan direction of the saturation region are read from the line memory, and a linear interpolation process is performed according to the pixel position in the saturation region. In this example, calculation and interpolation are performed so as to change linearly between data “50” immediately before the saturation region and data “55” immediately after the saturation region. Therefore, even though the distance data has different values at both end positions of the saturation region, it is possible to perform the interpolation process so that the data is continuously connected at the both ends.

Note that, in a case in which a frame memory is used instead of the line memory, it is possible to perform an interpolation process in which the data is continuous in both of the horizontal direction and the vertical direction.

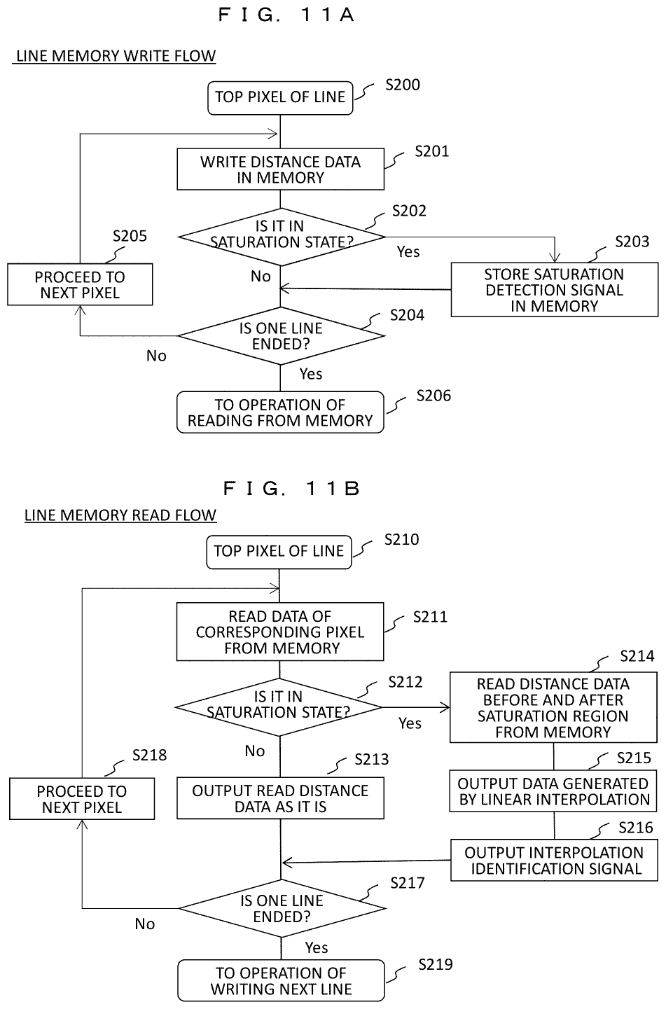

FIGS. 11A and 11B are flowcharts showing the procedure of the data interpolation process by the interpolation processing unit 15. In this example, a line memory is used, and an operation (FIG. 11A) of writing data for one line to the line memory and an operation (FIG. 11B) of reading data from the line memory are alternately repeated.

FIG. 11A: Line memory write flow

In S200, the process is started from the top pixel of the line. In S201, the distance data of the corresponding pixel is input from the distance calculation unit 13 and is written in the line memory. In S202, it is determined whether or not the light reception level of the pixel is saturated. This determination is the same as S102 of FIG. 8, and uses the detection result by the saturation detection unit 14.

In a case in which the light reception level is saturated, the process proceeds to S203, and a saturation detection signal is written to the corresponding pixel position of the line memory. In a case in which the light reception level is not saturated, the saturation detection signal is not written. In S204, it is determined whether the writing operation for one line is ended. In a case in which the writing operation is not ended, the process proceeds to the next pixel in S205, and the process from S201 is repeated. In a case in which the writing operation for one line is ended, the process proceeds to a data reading operation (FIG. 11B) from the line memory in S206.

FIG. 11B: Line memory read flow

In S210, the process is started from the top pixel of the line. In S211, the distance data of the corresponding pixel is read from the line memory. In S212, it is determined whether or not the corresponding pixel is saturated from the data (saturation detection signal) of the line memory. When the corresponding pixel is not saturated, the process proceeds to S213, and the read distance data is output as it is.

In a case in which the corresponding pixel is saturated, the process proceeds to S214, and two pieces of the distance data immediately before and after the non-saturation region adjacent to the saturation region are read from the line memory. A position of the data to be read at this time can be known by referring to the saturation detection signal written to the line memory. In S215, the distance data at the corresponding pixel position is generated and output by the linear interpolation, by using the read two pieces of the distance data. In addition, in S216, the interpolation identification signal indicating that the data interpolation is performed is output.

In S217, it is determined whether the reading operation for one line is ended, and in a case in which the reading operation for one line is not ended, the process proceeds to the next pixel in S218, and the process from S211 is repeated. In a case in which the reading operation for one line is ended, the process proceeds to the data writing operation (FIG. 11A) for the next line in S219.

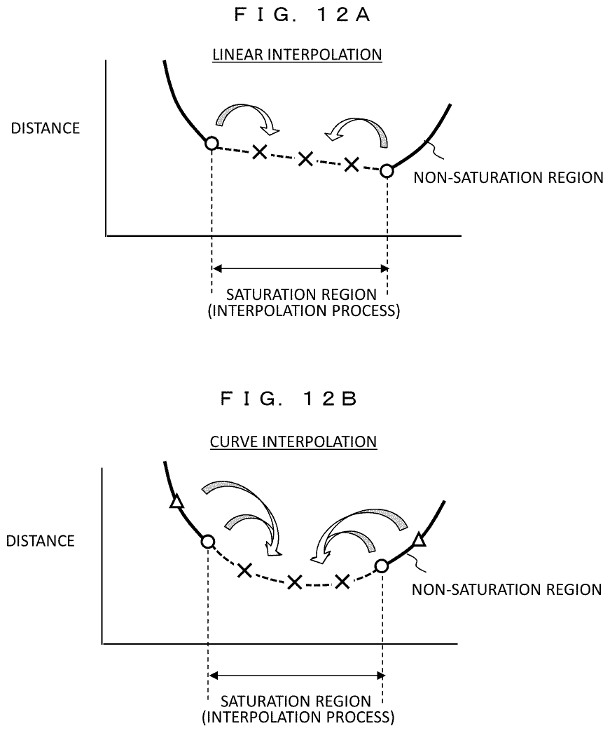

FIGS. 12A and 12B are diagrams for describing an interpolation method between two points. FIG. 12A is the case of the linear interpolation described with reference to FIG. 10, and the data value of each pixel is calculated so that the data value changes linearly using two values (◯ marks) at both ends of an interpolation period. FIG. 12B shows the case of curve interpolation using an approximation formula of a quadratic function or a cubic function in another method. In this case, in order to determine a coefficient of the quadratic function or the cubic function, not only the two values (◯ marks) at the both ends of the interpolation period but also a plurality of values (Δ marks) in the non-saturation region are used. According to the curve interpolation, it is possible to generate data in which the non-saturation region and the gradient smoothly connect at the both ends of the interpolation period.

Although in the above description, the interpolation is performed using the two pieces of data immediately before and after the non-saturation region adjacent to the saturation region, similarly to Example 1, in a case in which a transition region is present at the boundary between the non-saturation region and the saturation region, it is assumed that data of pixels of the non-saturation region close to each other across the transition region is used.

According to Example 2, similarly to Example 1, even in a case in which the saturation occurs in a partial region of the subject, it is possible to supplement the distance data by the interpolation process. In particular, it is possible to preferably interpolate the distance data in a case in which the distance data changes significantly in the saturation region in which it is determined that the measurement is impossible.

In each of the examples described above, although the person has been described as the subject to be measured, it is needless to say that the present invention can be similarly applied to a case in which a subject other than the person is to be measured.

Furthermore, in the description of each of the examples, a case in which the inclination angle is not uniform is taken as the surface state of the subject, but the present invention can also be similarly applied to a case in which a part of the surface is saturated due to a non-uniform reflectance. Furthermore, even in a case in which a step is present on the surface of the subject and a flat region on one side or both sides of the step is saturated, a step portion is the inclination and can be measured without saturation, and thus it is possible to interpolate distance data of the saturated flat region using measurement data of the step portion.

What is claimed is:

1. A distance measurement device that measures a distance to a subject by a flight time of light, the distance measurement device comprising:
a light emitting unit that irradiates the subject with light generated from a light source;
a light receiving unit that detects light reflected from the subject by an image sensor in which pixels are arranged in a two-dimensional shape;
a distance calculation unit that calculates the distance to the subject for each pixel position from a detection signal of the light receiving unit and outputs distance data;
a saturation detection unit that detects that a light reception level of the image sensor in the light receiving unit is saturated;
an interpolation processing unit that performs an interpolation process using the distance data of a non-saturation region close to a saturation region on the distance data of the saturation region among the distance data output from the distance calculation unit when the saturation detection unit detects the saturation; and
an image processing unit that generates a distance image of the subject on the basis of the distance data output from the interpolation processing unit.

2. The distance measurement device according to claim 1, wherein, in the interpolation process of the interpolation processing unit, the distance data of each pixel in the saturation region is replaced with the distance data of one pixel of the non-saturation region close to a scan direction of the image sensor.

3. The distance measurement device according to claim 1, wherein, in the interpolation process of the interpolation processing unit, the distance data of each pixel in the saturation region is calculated by using the distance data of a plurality of pixels in the non-saturation regions close to each other before and after in a scan direction of the image sensor.

4. The distance measurement device according to claim 3, wherein, in the interpolation process of the interpolation processing unit, the distance data of each pixel in the saturation region is calculated by calculation of linear interpolation or curve interpolation using a plurality of pieces of the distance data of the non-saturation regions close to each other before and after.

5. The distance measurement device according to claim 1, wherein, when a charge amount accumulated in the image sensor reaches a maximum value or a predetermined saturation value, the saturation detection unit determines the saturation and outputs a saturation detection signal.

6. The distance measurement device according to claim 5, wherein the interpolation processing unit gives and outputs an interpolation identification signal to the distance data on which the interpolation process is performed.

7. The distance measurement device according to claim 6, wherein the interpolation identification signal is configured of a digital signal of a high or low level different from an acquired value of the distance data or a specific code pattern.
